(19) United States
(12) Patent Application Publication
(10) Pub. No.: US 2006/0166372 A1
(43) Pub. Date: Jul. 27, 2006

(54) Method for fillling sample carriers

(76) Inventor: Hartwig Preckel, Hamburg (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/542,437

(22) PCT Filed: Jan. 23, 2004
(86) PCT No.: PCT/EP04/00565

§ 371 Date: Mar. 24, 2006

(30) Foreign Application Priority Data
Jan. 23, 2003 (DE) 103 02 464.6

(51) Int. Cl. B01L 3/00

(52) U.S. Cl. 436/180

(57) ABSTRACT

A method for filling sample carriers with chemical and/or biological liquids can be performed by means of a liquid dispensing device. The liquid dispensing device comprises a liquid chamber. The liquid chamber is acted on by a piezo actors. Through an activating pulse generated by the piezo actor, liquid droplets are discharged from a discharge opening towards a sample carriers. In this manner, deepened portions are filled. To avoid an occurrence of wetting in the region of the discharge opening, a prepulse is generated prior to the generating of the activating pulses and a damping pulse is generated upon completion of the filling process.

The invention relates to a method for filling sample carriers with chemical and/or biological liquids.

In the dispensing and pipetting of quantities of liquid ranging from a few nanoliters up to the microliter level, droplets of a very small volume are discharged through a nozzle with the aid of liquid dispensing devices, particularly micropumps. Normally, the droplets will be collected in a very small target region, e.g. a deepened portion (well) in a microtitration plate or a region of the object carrier. The dosage quantity is determined by the number of the discharged droplets which have a very small volume, normally in the magnitude of picoliters. A commonly used technology involves the use of micropumps together with a piezo actor. Such liquid dispensing devices comprise a pump chamber having at least one side wall arranged to be flexible in the form of a membrane. By means of the piezo actor, the membrane and thus the liquid can be subjected to a pressure pulse. Under the effect of the thus generated pressure increase in the pump chamber, a droplet will be discharged through the discharge nozzle. Usually, the pump chamber is connected to a liquid reservoir. In dispensing devices, the sample liquid to be dispensed is contained in the liquid reservoir; Usually, in pipetting devices wherein the to-be-dispensed sample liquid is sucked through the pipetting tip prior to dispensing and subsequently is dispensed, a system liquid is contained in the liquid reservoir.

Due to their operating principle, these pumps are highly susceptible to failure. However, for use in unsupervised automatic systems, e.g. for medium- or high-throughput screening, a reliable operation of the pumps is imperative. Thus, disturbances have to be avoided. A frequent problem during the operation of micropumps resides in contamination such as deposits or wetting on the discharge nozzle generated by components of the dispersed reagents. Deposits or wetting on the discharge nozzle will cause changes of the direction of the beam and thus will normally entail a defective filling of the sample carrier. They can be eliminated by cleansing or swabbing the nozzle. This, however, is extremely time-consuming. Further, this fault is difficult to detect automatically, particularly if, in a system installed in a restricted space, very large numbers of pumps are used simultaneously. To allow for a robust, unsupervised operation, the occurrence of this fault must be precluded.

As a triggering signal for the piezo actor, use is normally made of a periodic sequence of square-wave pulses or similar step-shaped or trapezoidal pulses. With each pulse, a droplet is ejected.

The micropumps which in liquid dispensing devices are employed for the filling of deepened portions (wells) of a sample carrier are normally used in permanent or burst operation. In burst operation, droplets are dispensed continuously over a longer period of time by periodic activation the piezo actor. Thus, a burst is a group of a plurality of droplets (series of droplets) which are dispensed in rapid succession, a burst being followed by a longer pause before the next burst is performed. Thus, a burst is a series of droplets, and one liquid dispensing step can comprise a plurality of series of droplets. Within a burst, there will thus occur no swinging movement of the micropump or the liquid dispensing device. In the pause between two liquid dispensing steps which, depending on the given case, may comprise a plurality of bursts, there is performed e.g. a positioning of the dispensing or pipetting device into a position above the next deepened portion (well) of a microtitration plate by moving the liquid dispensing device and/or the titration plate. A burst is 0.1 to 1 seconds long, for instance. In the course of a burst, e.g. while wells are being filled, about 20 to 1000 droplets will be dispensed. In this regard, the total volume is determined by the number of droplets, which number corresponds to the number of pulses emitted by the piezo actor to the pump chamber.

In principle, also single-droplet dispensing is possible. This makes it possible to dispense an extremely small, exactly dosed quantity of liquid.

Research has revealed that the danger of a wetting of the nozzle occurs particularly in burst operation at the start and primarily at the end of a pulse sequence. By the wetting, the direction of the beam at the following burst will be changed. Drying of the wetting matter will cause the detached substances to deposit around the nozzle opening. This, too, will lead to an instable orientation of the beam or to failure of the liquid dispensing device.

The risk of wetting on the outer faces of the nozzle can be reduced by providing the nozzle with a hydrophobic coating. A known method is the silanization of the glass surfaces of the nozzle. A hydrophobic coating of the nozzle, however, suffers from the disadvantages that the effect is restricted to hydrophilic reagents, that the adhesion of reagents at low concentrations will cause problems, that the coating—especially in case of frequent rinsing and swabbing—does not have a long-term stability, that a hydrophobic coating may disturb the meniscus formation in the nozzle opening and thus may cause an instable operation.

As a further possibility for minimizing the wetting of the nozzle, one can select a nozzle of a shape as pointed as possible to thus keep the wettable surface small. However, a very pointed shape of the nozzle to thereby minimize the wettable surface will cause the disadvantages that the mechanical stability is reduced, that the manufacture is more difficult and expensive and that there exists no technical possibility to make the wettable surface sufficiently small to the effect that no liquid at all will adhere.

It is the object of the invention to provide a method for the filling of sample carriers wherein the danger of a formation of deposits or wetting on the discharge nozzle of a liquid dispensing device is reduced.

According to the invention, the object is achieved by the features indicated in claim 1 and 3, respectively.

It has been found that the tendency to wetting on the nozzle at the start of the activating pulse sequence is caused e.g. by the fact that the dispenser has not yet reached its full oscillating state and the droplet is thus ejected with a lower pulse. Further, it has been found that the tendency to wetting of the nozzle at the end of the activating pulse sequence is caused by postoscillation of the dispenser. During postoscillation, liquid is pressed out from the nozzle but is not delivered anymore in the form of droplets. The liquid will either be sucked back into the nozzle or will wetten the outer surface of the nozzle by adhesion forces.

In a first variant of the inventive method for the filling of deepened portions of a sample carrier, the wetting or deposit caused by postoscillation is reduced or completely eliminated. According to the inventive method, a positioning step is performed in which the liquid dispensing device, i.e. the dispenser, is positioned above a first deepened portion (well), the positioning being effected by moving the liquid dispensing device and/or the sample carrier. The liquid dispensing device comprises a liquid chamber, wherein the liquid chamber is acted on by a pulse generator and droplets are generated by an activating pulse. Preferably, the dispensing of the droplets towards the deepened portion is carried out via a capillary channel provided in the dispenser. After the positioning step, a liquid dispensing step is performed wherein, by activating the pulse generator, a plurality of droplets are dispensed into the first deepened portion. A liquid dispensing step comprises at least one series of droplets in which a plurality of droplets are dispensed. Thereafter, the positioning step is repeated wherein the liquid dispensing device is positioned above a further deepened portion and, in the subsequent liquid dispensing step, this deepened portion is filled by dispensing a plurality of droplets within one or a plurality of series of droplets. The positioning step and the subsequent liquid dispensing step will be repeated a plurality of times as to fill all desired deepened portions. To avoid wetting and deposits due to postoscillation of the liquid dispensing device, it is provided according to the inventive method that the pulse generator will generate a damping pulse at the end of the series of droplets. Thus, according to the invention, on the one hand, a plurality of droplets (burst) are generated through activating pulses while the liquid dispensing device is made to oscillate. According to the invention, at the end of the burst or the series of droplets, these oscillations are dampened by at least one damping pulse. The damping pulse is generated e.g. at the end of a droplet dispensing cycle, particularly in the range of the last dispensing of droplets and with particular preference immediately after the last dispensing of droplets. By suitable selection of the point of time at which the damping pulse is generated, the oscillation of the liquid dispensing device can be considerably dampened. This will result at least in a reduction or even in a complete avoidance of the danger of wetting.

In a second preferred variant of the inventive method, a reduction of the danger of deposits or wetting is effected at the start of an activating pulse sequence. According to the invention, this purpose is served by a prepulse generated at the beginning of the series of droplets at a time prior to the activating pulses. According to the invention, the amplitude of the prepulse is larger than that of the activating pulse. Thus, already the first droplet is discharged with a high pulse, thus lessening the danger of a wetting of the nozzle. In case of a relatively weak first pulse which e.g. corresponds to the other activating pulses, it may happen that the nozzle is wetted because a part of the first droplet can keep adhering to the nozzle. By an increased first pulse, such occurrences are excluded. On the other hand, a permanent operation with a high amplitude would lead to failure of the dispenser because, due to the high amplitude, air would be drawn through the nozzle into the dispenser chamber when the liquid column recedes.

The provision of a prepulse with higher amplitude offers the further advantage that also the volume of the first droplet will be substantially of the same size as the volumes of the droplets generated by the later activating pulses. In case of a constant amplitude, the volume of the first droplet would be smaller because the system has not yet reached its full oscillating state.

Particular advantages can be obtained by combining the two above described inventive methods so that both a prepulse and a damping pulse are provided. By the provision of the damping pulse, the generation of deposits or wetting on the discharge nozzle can be reduced or even completely avoided. Thereby, failure of the liquid dispensing device or the necessity of cleaning will occur not at all or only much more rarely. Particularly, when applying the inventive method, the beam direction, i.e. the direction of the dispensing of the liquid droplets, will not be affected anymore; thus, especially when filling deepened portions of a microtitration plate or the like which have very small cross-sectional openings, it is safeguarded that the dispensed liquid will indeed enter the corresponding deepened portion. By a combination of the two inventive methods, i.e. by providing a prepulse and a damping pulse, these advantages will still be improved.

Further, very short burst lengths or operating cycles with—if desired—short pause periods are rendered possible. Particularly because of the inventive provision of a damping pulse, the postoscillation time of the system is considerably reduced. This offers the possibility of a massive reduction of the pause periods between two operating cycles or bursts. Without the provision of a damping pulse and/or a prepulse, such operating conditions would be unstable. It is thus made possible, for instance, to fill reagents into a merely several-microliter-sized deepened portion containing deposited cells without altering the uniform distribution of the cells on the bottom of the deepened portion. This is of importance for the selecting or examining of assays with suspension cells.

Preferably, the damping and/or prepulse is generated by that pulse generator which also generates the activating pulses for the dispensing of droplets.

In the method of the invention, it is particularly preferred that the system, i.e. substantially the liquid dispensing device as such, be operated at resonant frequency. Particularly within a burst, the activating pulses are preferably transmitted at intervals tuned to the resonant frequency of the system. Therefore, the new activating pulse is synchronized with the first postoscillation of the system. Thus, use is made of the inherent oscillation of the system. Further, operation at inherent frequency is advantageous because a wetting of the nozzle by sample liquid is avoided also within a burst because wetting could occur at the earliest with the first postoscillation and, according to the invention, this postoscillation is already utilized for discharging the next droplet. Thus, when operating the system at resonant frequency, the activating pulses are generated in dependence on the resonant frequency of the system at a constant time interval t. Preferably, in a system operated at resonant frequency, the postpulse according to the invention is generated at a time interval t/2 subsequent to the preceding activating pulse. Performing the method at resonant frequency allows for a particularly fast dispensing of the droplets and thus for use of the method in high-throughput screening.

The damping pulse is generated preferably substantially after the dispensing of the last droplet. It is especially preferred to generate the damping pulse immediately subsequent to the last pulse of the dispensing of liquid, particularly within the next oscillation cycle. In the process, the damping pulse is preferably oriented opposite to the postoscillation direction of the liquid dispensing device. Therefore, with an e.g. sinusoidal activation by the piezo actor at the resonant frequency of the liquid dispensing device and thus a sinusoidal oscillation of the liquid dispensing device and the system, respectively, the damping pulse is preferably of a phase opposite to that of the present oscillation phase of the activation and acts against the oscillation of the device, respectively.

The amplitude of the damping pulse is preferably at least 20% and more preferably at least 30% of the amplitude of the activating pulses. Particularly favorable results were obtained with amplitudes in the range of 50% of the amplitude of the activating pulse.

With particular preference, the length of the damping pulse is varied in dependence on the length of the activating pulse, wherein an improvement of the results is obtained by lengthening the duration of the damping pulse relative to the activating pulse by preferably 3 to 15%, and more preferably by 5 to 10%.

The amplitude of the prepulse is preferably by at least 20% and more preferably by at least 50% larger than the amplitude of the activating pulse. The selection of the size of the amplitude of the prepulse is dependent, inter alia, on the viscosity of the liquid. With various liquids, good results have been obtained by increasing the prepulse by 50 to 100%.

Particularly in medium- or high-throughput screening, the individual deepened portions are filled in an activation cycle or burst by dispensing at least 5, preferably at least 10 and more preferably at least 20 droplets.

Preferred embodiments of the invention will be described hereunder with reference to the accompanying drawings.

In the drawings:

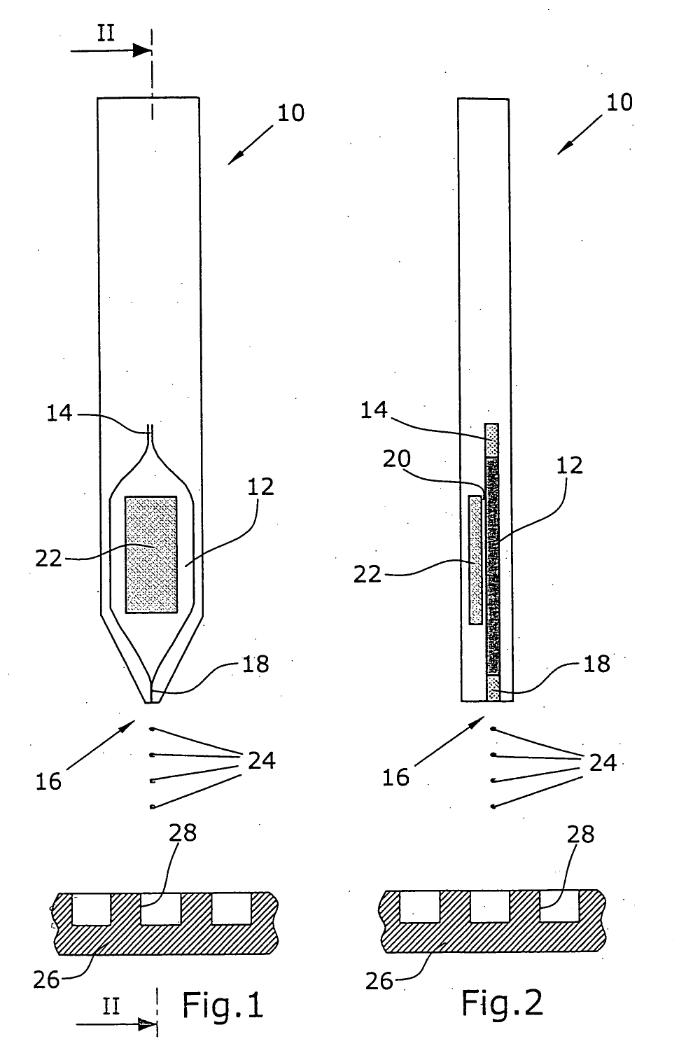

FIG. 1 is a schematic front view of a liquid dispensing device,

FIG. 2 is a schematic lateral view taken along the line II-II in FIG. 1,

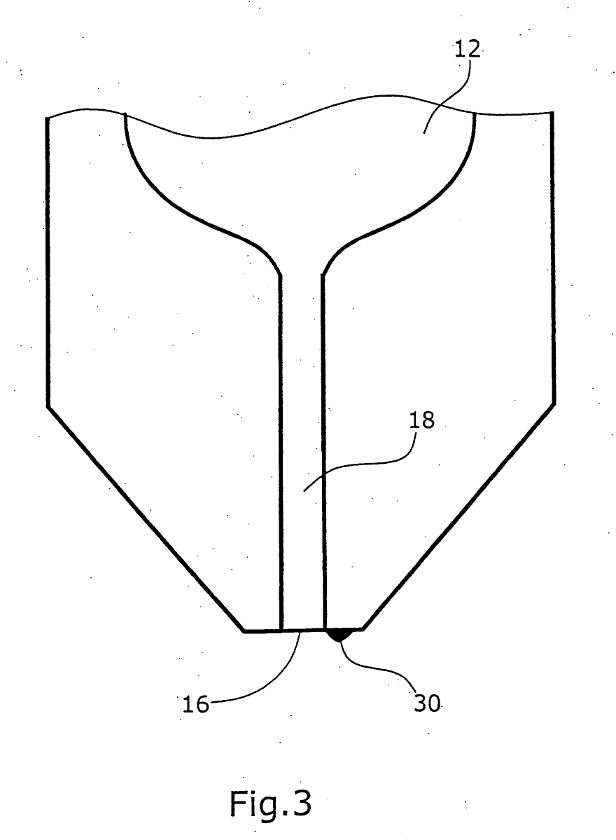

FIG. 3 is a schematic enlarged view of a discharge opening of the liquid dispensing device,

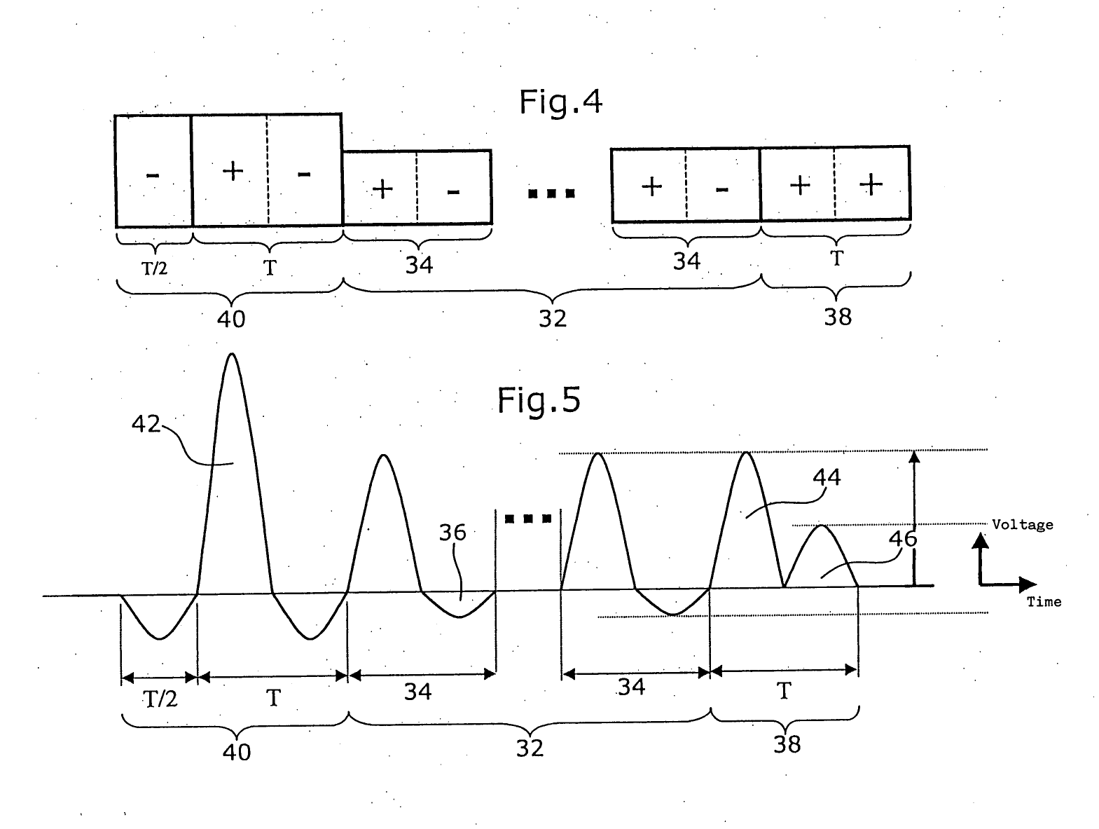

FIG. 4 is a schematic representation of a development of an activating pulse, and

FIG. 5 shows a concrete example of the development of the activating pulse over time.

A liquid dispensing device 10 (FIGS. 1 and 2) comprises a liquid chamber 12. The liquid chamber is connected via a channel 14 to a supply container, not illustrated. The liquid chamber is provided with a discharge channel 18 extending towards a discharge opening 16. The discharge channel 18 is preferably formed as a capillary channel.

A rear wall 20 (FIG. 2) of the liquid chamber 12 is provided to be flexible, especially in the form of a membrane. Externally of liquid chamber 12, a piezo actor 22 is arranged near the rear wall 20 and is connected to an electric control unit. By suitable control of the piezo actor 22, short pulses will be transmitted to liquid chamber 12. Thereby, droplets are ejected through the discharge opening 16. The piezo actor 22 thus serves as a pulse generator adapted to transmit pulses to liquid chamber 12 at very short time intervals.

The droplets 24 are discharged towards a sample carrier 26 and are used to fill deepened portions or wells 28 provided in the sample carrier 26.

According to the invention, liquid dispensing devices of this type, such as the dispenser illustrated in FIGS. 1 and 2 or a corresponding pipetting device, are operated preferably in the resonant frequency range. For this purpose, using the piezo actor 22 operated at a high frequency, the liquid dispensing device 10 is caused to oscillate. Upon termination of a liquid dispensing cycle or an activating cycle, a postoscillation of the liquid dispensing device 10 takes place. Due to this postoscillation, slight quantities of liquid will exit from the discharge opening 16 (FIG. 3). This may give rise to wetting or deposits 30 in the region of discharge opening 16. Corresponding wetting or deposits 30 can also be generated because, at the beginning of an activating cycle, the liquid dispensing device does not yet discharge the droplet at a sufficiently high speed since the liquid dispensing device has not yet reached its full oscillating state.

To avoid the occurrence of such deposits or wettings 30 or at least reduce the risk of such deposits, the pulses by which the piezo actor 22 is driven are generated in the manner provided by the invention, e.g. as shown in FIGS. 4 and 5.

Within an activating cycle 32 according to the invention, i.e. within a burst process or liquid dispensing step wherein a plurality of droplets 24 are continuously dispensed for filling the deepened portions 28, a continuous generating of activating pulses 34 is performed (FIG. 5). Each activating pulse 34 comprises e.g. a sinusoidal wave with an amplitude A. The negative half-wave 36 of a sinusoidal wave has a considerably lower amplitude, e.g. 10% of amplitude A. The Frequency 1/T corresponds to the resonant frequency of the liquid dispensing device 10. The liquid dispensing pump 10, as used in medium- or high-throughput screening, is operated with a frequency of 3,000 to 4,000 Hz.

The Amplitude A is 40 Volts. The sinus signal is used to activate only the main mode in the system and avoid disturbances by higher modes. The resonant frequency is used to obtain a large amplitude by use of a small activation signal. This is further necessary so that, also in the transients, there will be a known phase relation between the activating signal and the membrane oscillation. Thereby, at the end of the liquid dispensing step, a damping pulse 46 which is opposite in phase to the activating pulse 34 or the second half-wave 36, can be generated in a simple manner while obviating the need to measure or calculate the membrane oscillation. Preferably, an asymmetrical amplitude is employed so that, on the one hand, good use will be made of the working range of the piezo element and the silicon membrane and, on the other hand, the piezo element will not be destroyed by too large negative voltages.

A prepulse occurring at the beginning of the liquid dispensing cycle is a normal activation pulse having an amplitude enlarged by the factor 2. In the illustrated embodiment, the signal starts with the negative half-wave to thus obtain a larger discharge speed of the first droplet.

Prior to the damping pulse 46, a first half-wave 44 of an activating pulse is provided. The second half-wave (negative half-wave) is replaced by a positive half-wave, the damping pulse 46, with an amplitude by 50% smaller than that of the first half-wave 44. The second, positive half-wave thus serves as a damping pulse 46. Since the system is operated in resonance and is in its full oscillating state, this damping pulse 46 effects a strong damping of postoscillation.

Particularly the shape of the prepulse 40 can be varied, while a square shape of the prepulse would be of advantage. Further, the amplitude as well as the length of the prepulse 40 are variable. This applies also to the shape of the damping pulse 46 as well as the size and length of its amplitude.

Instead of dispensing a plurality of droplets with small volume into a well of a microtitration plate, it is also possible, for instance, to dispense the volume onto a plane object carrier. Because of the small volume, a drop will be formed on the object carrier and adhere thereon.

What is claimed is:

1. A method for filling deepened portions of a sample carrier with chemical and/or biological liquids comprising:
positioning a liquid dispensing devices above a first deepened portion, the liquid dispensing device comprising a liquid chamber which, for generating the droplets, is subjected to an activating pulse provided by a pulse generators,
in a liquid dispensing step, producing at least one series of droplets, wherein in a series of droplets a plurality of droplets are dispensed into the first deepened portion, and
performing plural repetitions of the positioning step for positioning the liquid dispensing device above further deepened portions as well as of the liquid dispensing step for dispensing a plurality of droplets in at least one series of droplets into this deepened portion,
wherein a damping pulse generated by the pulse generator at the end of the series of droplets for damping the postoscillation of the liquid dispensing device.

2. The method according to claim 1 wherein, at the beginning of the liquid dispensing step, a prepulse of a higher amplitude than that of the activating pulse is generated by the pulse generator prior to the first activating pulse.

3. A method for filling deepened portions of a sample carrier with chemical and/or biological liquids comprising:
positioning a liquid dispensing devices above a first deepened portion, the liquid dispensing device comprising a liquid chamber which, for generating the droplets, is subjected to an activating pulse provided by a pulse generators,
in a liquid dispensing step, producing at least one series of droplets, wherein in a series of droplets a plurality of droplets are dispensed into the first deepened portion, and
performing plural repetitions of the positioning step for positioning the liquid dispensing device above further deepened portions as well as of the liquid dispensing step for dispensing a plurality of droplets in at least one series of droplets into this deepened portion,
wherein a prepulse generated by the pulse generator at the start of the series of droplets and transmitted prior to the first activating pulse, the amplitude of the prepulse being larger than that of the activating pulse.

4. The method according to claim 3 wherein, at the end of the liquid dispensing step, a damping pulse is generated by the pulse generator for damping the postoscillation of the liquid dispensing device.

5. The method according to claim 1, wherein, in operation at resonant frequency, the damping pulse is generated by phase reversal of the activating pulse.

6. The method according to claim 1 wherein the damping pulse is generated substantially after the dispensing of the last droplet dispensed for filling.

7. The method according to claim 1 wherein the damping pulse substantially counteracts the preset oscillation of the liquid dispensing device.

8. The method according to claim 1 wherein the amplitude of the damping pulse is at least 20% of the amplitude of the activating pulse.

9. The method according to claim 1 wherein the duration of the damping pulse is longer than the duration of the activating pulse.

10. The method according to claim 2 wherein the amplitude of the prepulse is at least 20% larger than of the amplitude of the activating pulse.

11. The method according to claim 2 wherein the prepulse causes the first droplet to be dispensed.

12. The method according to claim 1 wherein, for filling the deepened portion, at least 5 droplets are dispensed.

13. The method according to claim 1 wherein the liquid dispensing device is operated at resonant frequency.

14. The method according to claim 1 wherein the dispensing of liquid is performed via a capillary chamber provided in the liquid dispensing device and connected to the liquid chamber.
